(19) United States
(12) Patent Application Publication
(10) Pub. No.: US 2014/0235325 A1
(43) Pub. Date: Aug. 21, 2014

(54) FINANCIAL GAMING MANAGEMENT SYSTEM AND METHOD

(71) Applicant: Bruce Merati, San Diego, CA (US)

(72) Inventor: Bruce Merati, San Diego, CA (US)

(21) Appl. No.: 13/770,214

(22) Filed: Feb. 19, 2013

(51) Int. Cl. G07F 17/32

(52) U.S. Cl. CPC G07F 17/3244
USPC 463/25; 463/42

(57) ABSTRACT

A system, apparatus, and method for providing accounting between and among different gaming platforms, comprising a first gaming platform for allowing an individual to participate in a game being played on a second gaming platform, and for receiving a wager from the individual via the first gaming platform for use in the game, and a server coupled to the first gaming platform and the second gaming platform for determining an amount owed to the first gaming platform by the second gaming platform depending on an outcome of the wager.

### BACKGROUND

I. Field of Use

The present application relates generally to the gaming industry. More specifically, the present application is a system and method for financial management relating to the gaming industry.

III. Description of the Related Art

Casino-based gaming has been popular for decades, gaining a foothold in the United States in Las Vegas in the early 1930's. Since then, numerous states offer some form of regulated gaming and many US states offer numerous types of gaming in the form of riverboats gambling, Indian casinos, card rooms, bingo halls, lotteries, and racetracks. Internationally, gaming has gained widespread acceptance, popular in countries such as Singapore, Macao, Malaysia, and many others.

Traditional casinos have typically offered a wide variety of games of chance to their customers. For example, a casino may offer live gaming in the form of blackjack, poker, craps, and roulette. Other examples include electronic gaming, such as slot machines, video poker, and other electronic games. Further, casinos may offer sports betting.

Recently, on-line gaming has also become popular, enabling individuals to play games such as poker, blackjack, and other games of chance against other individuals playing on-line. To date, casinos have been precluded somewhat in offering on-line gaming, due to the strict regulatory nature of most jurisdictions. However, it is likely that casinos will soon be able to offer on-line individuals opportunities to participate in live games being played at the casinos.

Traditionally, casinos have employed sophisticated accounting systems to track monies received and paid out to their customers. A casino may have multiple accounting systems in use to track different types of gaming activity. For example, a casino may employ a computerized system using the well-known Slot Accounting System (SAS) protocol developed by IGT of Las Vegas, Nev. The SAS protocol has been in use for many years, allowing casinos to account for activities occurring on their slot machines and other electronic gaming devices. Another type of accounting system tracks financial transactions for live play games, such as live blackjack, craps, roulette, and poker. In this system, a live dealer typically takes responsibility for a large “bank” of clay chips for use in a live game, the chips representing a large dollar amount. At the end of the dealer's shift, the chips are counted, along with any money or vouchers received during his or her shift, where it is reconciled by humans, for example, casino personnel working in a secured area known as “the cage”. Other types of wagering may employ a separate accounting system. For example, a casino's sports betting area may use an accounting system specialized to track sports betting, while live keno or bingo games may use another accounting system.

The above-mentioned accounting systems have, this far, been able to provide casinos with an accurate accounting of wagering that occurs on their properties. However, this may not be the case for very much longer. In the near future, it may be possible for individuals playing on one gaming platform to play games against/with individuals playing on another gaming platform. For example, an individual located at home playing on-line might be able to play a game of live blackjack against a live dealer in a casino. In this case, wagers would be received electronically from the individual, rather than traditional clay chips from individuals playing at the blackjack table. Payouts to the on-line individual, likewise, would be in the form of an electronic payment or credit, rather than a reduction in clay chips in possession of the blackjack dealer. This “cross-platform” gaming causes an imbalance in the “live blackjack” accounting system. Similarly, it causes an imbalance in an accounting system attempting to account for the on-line player's wagers received and pay-outs paid.

Thus, it would be desirable to be able to account for gaming that occurs across different gaming platforms.

### SUMMARY

The embodiments described herein relate to a method, system, and apparatus for financial management of a networked gaming system. In one embodiment, a system is described, comprising a first gaming platform for allowing an individual to participate in a game being played on a second gaming platform, and for receiving a wager from the individual via the first gaming platform for use in the game, and a server coupled to the first gaming platform and the second gaming platform for determining an amount that may be owed to the first gaming platform by the second gaming platform depending on an outcome of the wager.

In another embodiment, an apparatus is described, comprising a communication interface for sending and receiving wagering and game outcome information between a first gaming platform and a second gaming platform, a memory for storing account information related to the wagering and game outcome information between the first gaming platform and the second gaming platform, and a processor configured to determine an amount owed to the first gaming platform by the second gaming platform, or by the second gaming platform to the first gaming platform, based on wagering and game outcome information.

In yet another embodiment, a method is described, comprising receiving an indication of a wager placed by an individual using a first gaming platform over a network interface, the wager for use in a game being conducted on a second gaming platform, adjusting an account balance stored in a memory, the account balance associated with an amount owed between the first gaming platform and the second gaming platform, receiving an indication from an electronic device associated with the second gaming platform whether the wager was successful or unsuccessful over the network interface, adjusting the account balance in accordance with the wager's outcome, and determining an amount owed from the first gaming platform to the second gaming platform, or vice-versa, depending on the account balance.

### BRIEF DESCRIPTION OF THE DRAWINGS

The features, advantages, and objects of the present invention will become more apparent from the detailed description as set forth below, when taken in conjunction with the drawings in which like referenced characters identify correspondingly throughout, and wherein:

FIG. 1 illustrates a block diagram of a prior art casino that provides a number of different games of chance to its customers;

FIG. 2 is a block diagram illustrating a casino, featuring a central accounting system that is used to provide accounting and reconciliation for various gaming platforms as players are allowed to engage in “cross-platform” wagering;

FIG. 3 is a block diagram illustrating another embodiment of an accounting system used to account for and reconcile accounts between and among various accounting systems as players are allowed to engage in cross-platform wagering;

FIG. 4 is a block diagram of another embodiment, where individuals operating an electronic gaming machine in accordance with a first gaming platform in a first gaming establishment may play a game in accordance with a second gaming platform located in a second authorized gaming establishment;

FIG. 5 is a functional block diagram of one embodiment of either the central accounting system shown in FIG. 2 or an intra-casino accounting server shown in FIG. 4; and

FIG. 6 is a flow diagram illustrating one embodiment of a method for accounting for cross-platform wagering.

### DETAILED DESCRIPTION

The present description relates to financial accounting methods and apparatus related to the gaming industry. Such methods and apparatus are useful to track and/or reconcile accounts of different gaming platforms offered by one or more authorized or regulated gaming establishments, such as casinos or other governmentally-authorized venues.

The term “authorized gaming establishment” refers to herein as any place of business that has been authorized or regulated by any local, state, federal, or other governmental body, to provide gaming services to individuals. Such establishments may include traditional casinos, Indian casinos, bingo parlors, card rooms, racetracks, riverboats, bars, airports, restaurants, and virtually any other establishment that is authorized or licensed to provide gaming to its customers.

As used herein, the term “electronic gaming device” refers to an electronic or electro-mechanical device, located on the premises of an authorized gaming establishment, that allows a player to play one or more games, either against other players, against “the house”, e.g., authorized gaming establishment, or a combination of both. Such electronic gaming devices allow an individual to play games such as poker (in any number of its forms), roulette, craps, bingo, keno, slots, blackjack, and other games of chance and/or skill in real time or near real-time against other, real individuals and/or a house entity. In one embodiment, electronic gaming devices are manufactured in accordance with a set of standards such as those set by the Regulations of the Nevada Gaming Commission in, for example, “Technical Standards for Gaming Devices and On-Line Slot Systems”.

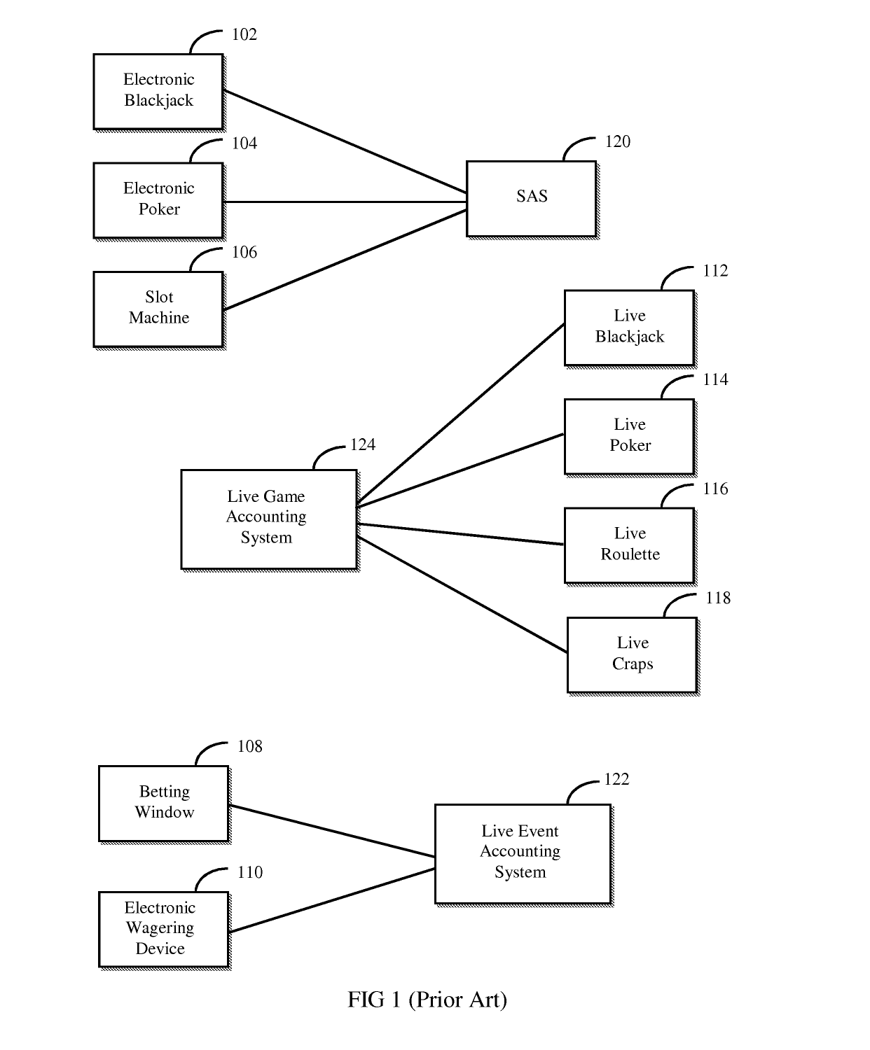

FIG. 1 illustrates a block diagram of a prior art authorized gaming establishment 100, in this case, a casino, that provides a number of different games of chance to its customers. For example, in this particular example, casino 100 offers its blackjack, poker, and slots via electronic blackjack machine 102, electronic, or “video” poker machine 104, and electronic slot machine 106, respectively. Casino 100 also offers live event wagering, such as the ability to place wagers on sports or race events, or other real-time events, such as wagering on who will win a beauty contest, who will win a reality-based TV show, etc. Live event wagering occurs via one or more “betting windows” 108, each attended by an authorized gaming establishment employee who accepts wagers from individuals, typically in the form of cash, vouchers, or credit cards, and provides pay outs to winners, again, typically in the form of cash, vouchers, or credit. Alternatively, or in addition, live event wagers may be placed with casino 100 via electronic wagering devices 110 comprising electronic machines capable of receiving wagers from individuals and, typically, providing a pay-out to individuals based on the outcome of a game, such as if their wagers were successful. Further still, casino 100 may offer live games of blackjack, poker, roulette, and craps to its customers via one or more physical blackjack tables 112, one or more physical poker tables 114, one or more physical roulette wheels 116, and one or more physical craps tables 118, respectively. Each of the live games is typically staffed with a live person to conduct game play.

In the prior art casino 100 shown in FIG. 1, three accounting systems are used to monitor the financial events occurring at each of the games. Specifically, SAS accounting system 120 monitors electronic games such blackjack machine(s) 102, video poker machine(s) 104, and slot machine(s) 106, live event accounting server 122 monitors live event wagering occurring at betting window 108 and/or electronic wagering device 110, and live game accounting system 124 monitors transactions occurring on physical blackjack table(s) 112, physical poker tables 114, physical roulette wheel(s) 116, and physical craps table(s) 118.

The SAS accounting system 120 comprises a computerized system using the well-known Slot Accounting System (SAS). Initially designed to automate slot machine meter reporting and event logging, SAS has steadily evolved over the years to include functions such as player tracking, bonusing, ticketing and cashless gaming. The Gaming Standards Association (GSA), representing a broad range of gaming industry manufacturers and operators, adopted SAS 6 as a recognized communications standard for the industry in July of 2002. SAS 6.02 complies with the latest Nevada Gaming Control Board Technical Standards for gaming machine accounting, as well as providing complete multi-game and multi-denomination accounting. SAS 6.02 also supports all of the features currently required for a modern casino, including Ticket In/Ticket Out (TITO), system bonusing and cashless gaming. The SAS accounting system 120 monitors an initial exchange of money, vouchers, or credit received from a game player as a game is initialed by the game player using one of the electronic gaming devices. It may also track the amount of each wager and the outcome of each round of game play to track the overall win/loss associated with the game player. When the game player is finished, he or she may receive cash or, more typically, a paper voucher from the electronic gaming machine if the game player has any credits remaining. The SAS accounting system uses the win/loss determination to determine an overall accounting of each electronic gaming device, as well as a reconciliation among monies received, monies paid-out, and monies “retained” by each of the devices. Monies retained essentially means the profit to an electronic gaming device after a player is finished with a gaming device. It may include cash inside a gaming device received from players and/or net electronic credits received from players via voucher, credit card, debit card, or any other form of electronic payment.

The live event accounting server 122 typically comprises a computerized system used to track deposits, wagers and pay-outs. In the case of betting window(s) 108, a live attendant may be responsible for accepting deposits, bets from individuals on various live events, and providing a pay out if bets are successful. Typically, the live attendant enters wagering information into live event accounting server 122 using a keyboard or a touch-screen device, such as wager amount and a particular outcome of a selected live event. If the wager is successful, the individual that played the bet receives a pay-out as determined by the odds of the live event occurring when the individual placed the bet. If the bet is unsuccessful, the casino 100 keeps the bet, some or all of which maybe a profit. Typically a bookmaker sets the odds to split people's opinion in half so that winning wagers are paid out of losing wagers less a handling fee kept for the bookmaker as a profit. Electronic wagering device(s) 110 operate in a similar fashion, except that no live attendant is provided, and individuals enter their own wagers on various live events in accordance with odds displayed by the electronic wagering device(s). Each wager is provided to live event accounting networked to server 122. If a bet is successful, an individual may be paid out via an electronic wagering device 110 or one of the betting windows 108. Thus, live event accounting server 122 tracks bets received and pay-outs paid to determine an overall win/loss amount for casino 100 over a given time period.

The live game accounting system 124 typically comprises a computerized system used to track wagers as they are received and pay-outs to individuals playing any of the live games offered by casino 100, such as live blackjack, live poker, live roulette or live craps. The wagers are typically in the form of cash, vouchers, or casino-issued gaming “chips”. Thus, live game accounting system 124 does not monitor in real time the financial events occurring at each table. Rather, a system of reconciliations, checks and balances, along with information, if needed, provided by video surveillance cameras, is used to account for the exchange of cash, chips, and vouchers between casino 100 and game players. Typically, a tray of gaming chips are issued by a “cage,” or bank area, in a casino to a casino employee, such as a dealer or a pit boss, in exchange for the employee's signature taking responsibility for the chips. An employee in the cage area manually record and or enter the information into a live game accounting system that a tray of gaming chips was issued to a particular casino employee, the table and the amount of the distribution.

The tray typically comprises thousands of dollars in gaming chips in various denominations. The employee may then place the tray of chips inside a lockable receiving area typically built into many game tables. When the casino decides to open a game table for business, a dealer, croupier, or boxman is assigned to a particular gaming table and asked to count the chips in the tray. The dealer, croupier, or boxman will then sign for the tray, taking responsibility for it. The casino pit boss may then enter the information manually into a sheet as well as into live game accounting system 124, indicating that a particular casino employee is now responsible for the chips, and other information, such as an identification of the gaming table where the chips reside.

Game play then begins at the gaming table. Typically, players take a position at a gaming table to play games such as blackjack, poker, roulette, or craps. They may bring chips to the table that have already acquired, or they may purchase chips from the dealer using cash, a voucher and, sometimes, a credit or debit card. Cash and vouchers are placed into a drop box located underneath the gaming table. The amount of chips in the tray decrease as players purchase gaming chips and increase as player losses are collected by the dealer during game play. Each table is monitored by at least one video camera to record card hands, dice rolls, or roulette spins. The recordings may be used to detect cheating or review any game play for any questionable situations.

At the end of the dealer, croupier, or boxman's shift, or end of some other time period the value of the chips in the tray are counted the amount entered into live game accounting system 124. Any cash or vouchers in the dropbox is totaled and also entered into live game accounting system 124. Live game accounting system 124 may then provide an accounting and reconciliation among the chips, cash, vouchers, and credit/debit card receipts to determine an overall profit/loss of each table game individually, and/or all of the table games collectively. For example, if the total amount of the chips in the tray plus the amount of cash and vouchers in the dropbox is greater than the value of the chips in the tray at the start of the shift, the casino 100 profited during the dealer's shift. If the value of chips in the tray plus the amount of cash and vouchers in the dropbox is less than the value of the chips in the tray at the start of the shift, the casino 100 lost money during the dealer's shift.

In the prior art, the above-described financial accounting records are separately tracked and managed. Thus, an accounting for the entire casino 100 is accomplished by summing the profit/loss results from each accounting system. Currently this provides an adequate accounting of results, however with the advent of cross-platform wagering, there is a need for the accounting systems to communicate with each other, as well as to provide cross-platform reconciliations, as will be described below.

In one embodiment, the term “gaming platform” may refer to a format in which a game is provided to an individual. For example, one format may comprise playing a game using an electronic gaming device, such as a slot machine, video poker machine, an electronic keno machine, an electronic bingo machine, a “pull-tab” machine, an electronic multi-game machine that may offer one or more of the aforementioned games, etc., while another format may comprise playing a live game. “Live” games may be defined as any game that does not require the use an electronic gaming device. Live games may, alternatively, be defined as any game that requires the presence of a live person, such as a dealer, croupier, boxman, or other authorized gaming establishment personnel, in order to play the game. Such games include blackjack, poker, roulette, and craps.

In another embodiment, the term “gaming platform” may refer to the manner in which information is exchanged between a player and an accounting system, game server, or a manual system. For example, one gaming platform may comprise any device that sends and receives wagering and game outcome information, over a wide-area network, such as the Internet. This may include personal computers, tablets, and smartphones configured to offer electronic versions of poker, blackjack, craps, roulette, keno, bingo, etc. A server owned, operated, or otherwise provided by casino 100, or a third party provider, typically provides a number of games in varying wagering denominations to potential game players. Alternatively, another gaming platform may include any game where wagers and pay-out information are provided by a human being, such as a dealer, croupier or boxman in any live, physical blackjack, poker, craps, or roulette game. Yet another gaming platform may comprise any device that sends and receives wagering and game outcome information over a local intranet, such as a slot machine, video poker machine, or electronic blackjack machine in communication with an accounting server or game server.

In another embodiment, a gaming platform may be defined by the type of random number generator used in the game. For example, a first gaming platform may be defined as any game using dice to determine game outcomes, and another gaming platform defined as any games based on real events occurring, such as sports betting. Other gaming platforms included in this embodiment comprises any game using physical playing cards, or any game using an electronic processor to generate random numbers, such as the case in modern gaming machines that generate electronic card values, electronic dice values, electronic roulette values, electronic keno numbers, or electronic bingo letters/numbers.

In yet another embodiment, gaming platforms may be classified accounting system. In other words, all games that are monitored by a single accounting system may be considered belonging to a first gaming platform.

In some embodiments, all electronic gaming devices in casino 100 are monitored by the SAS accounting system 120, for example slot machines, video poker, keno machines, bingo machines, electronic craps machines, etc. In other embodiments, only some electronic gaming devices are monitored by one accounting system, and others may use a second accounting system.

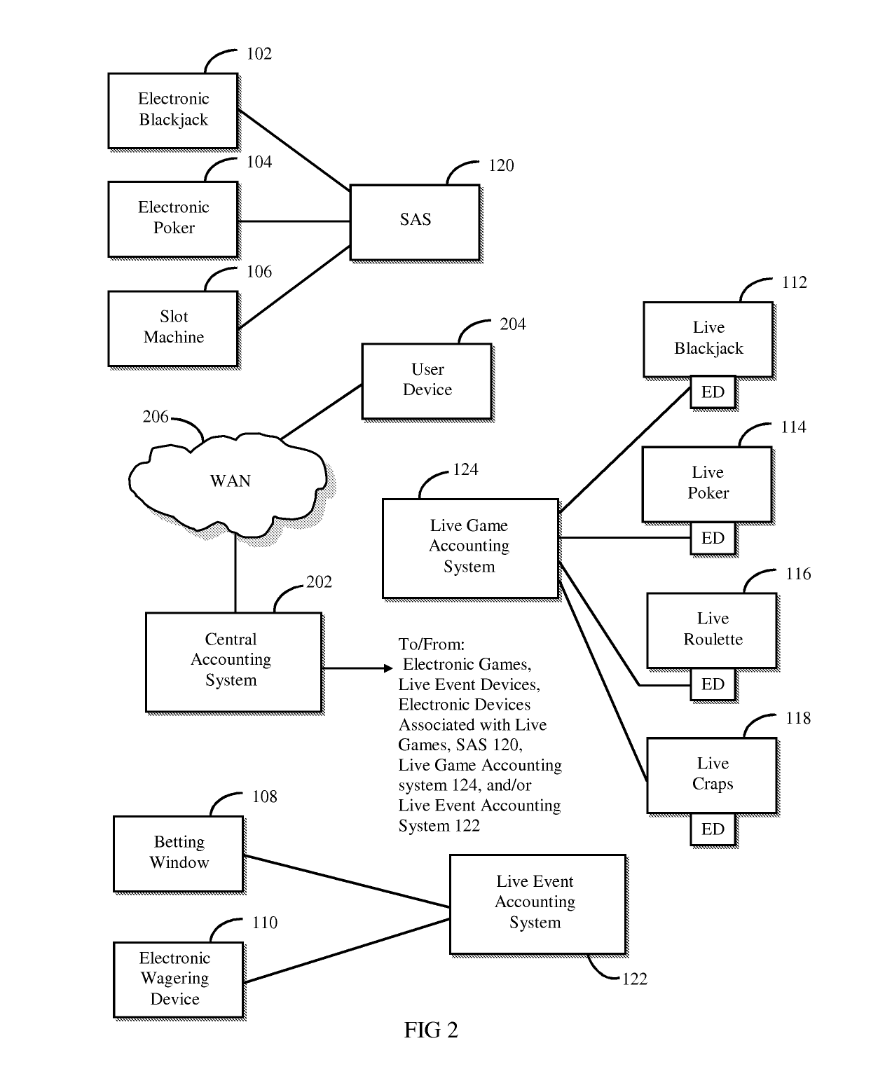

FIG. 2 is a block diagram illustrating casino 200, featuring a central accounting system 202 that is used to provide accounting and reconciliation for various gaming platforms as players are allowed to engage in “cross-platform” wagering. In this embodiment, central accounting system is shown as a separate entity. However, in other embodiments, the functionality of accounting systems 120, 122 and/or 124 may be incorporated into central accounting system 202. In this embodiment, each of the accounting functions previously provided by accounting systems 120, 122 and 124 may still be managed as separate accounting functions within central accounting system 202. Typically, this is accomplished using individual account programs, i.e., an accounting program that tracks accounting information from games offered by electronic gaming machine platforms, an accounting program that tracks accounting information from games offered on a live gaming platform, and an accounting program that tracks accounting information from games offered on a live event wagering platform. In one embodiment, a separate accounting program from the afore-mentioned accounting programs tracks cross-platform wagering, so that reconciliation can occur between/among the different gaming platforms, as explained above with respect to FIG. 2. In yet another embodiment, the functionality of each of the accounting systems may be combined as determined by those skilled in the art.

Although FIG. 2 shows central accounting system 202 coupled to SAS accounting system 120, live event accounting system 122, and live game accounting system 124 via communication links, such as electrical or fiber-optic cables, or wireless links, in other embodiments, central accounting system 202 may be coupled directly to electronic games, electronic devices (ED's) associated with live gaming tables, and/or electronic wagering devices. Information between/among the various functional blocks of FIG. 2 may be transferred along one or more of these communication links. The term “cross-platform” wagering refers to the ability for players to place wagers on one gaming platform by way of another gaming platform. For example, a player operating a slot machine may be able to place a wager on a live hand of blackjack being played at live poker table 114. A player engaged in live event gaming may use an electronic wagering device to not only place wagers with respect to live events, but also to place wagers on a video poker outcome, slot machine outcome, or a live game, such as poker, blackjack, roulette or craps.

Central accounting system 202 typically comprises a server or other computer to store accounting information for the various gaming platforms. For example, one account may be created for each gaming platform. In another embodiment, an account is created for each gaming platform pairing, such as an account relating to transactions occurring between the electronic gaming platform and live gaming platform and an account relating to transactions occurring between the live gaming platform and the live event gaming platform. Alternatively, or in addition, central accounting system 202 may also store player account information, such as identification information and an on-going account balance as individuals participate in gaming activities. As shown in FIG. 2, central accounting server 202 is electronically coupled to SAS accounting system 120, live event accounting server 122, and live game accounting system 124, typically by one or more electric or communication means and devices such as WIFI, RFID fiber-optic network cables, etc. In other embodiments, central server 202 may be coupled to individual gaming machines, rather than through the accounting systems. Each accounting system provides accounting support to their corresponding games, as shown, and as described above. However, the information sent and received from each accounting system may also be provided to central accounting server 202 for a system-wide accounting and reconciliation purposes, or this information may be provided to central server 202 and their respective accounting servers by the individual gaming machines themselves.

The live gaming tables may be equipped with an electronic device (labeled as “ED”) in order for a live person to enter and receive information, such as win/loss information, seat open information, seat assignment information, etc. It should be understood that in a typical casino, there exists many blackjack tables, poker tables, roulette wheels, and craps tables, wherein some or all of these tables are each equipped with a respective electronic device.

Each electronic device typically comprises an electronic microprocessor, memory, user input device and display, having one or more processor-executable programs stored on the memory that causes each electronic device to provide information to a dealer, boxman, or croupier, and to receive information from said individuals. Each electronic device further includes a means for communicating with a remote device, such as central account server 202, live game accounting server, and/or electronic device 204, such a network communication port, wireless transceiver, or other well-known means for transmitting and receiving information.

In one example, an individual may create an account with central accounting system 202 by providing central accounting system 202 personal information, such as a name, address, credit card information, username, and password, typically using an electronic device 204, such as a personal computer, tablet, or smartphone, to communicate with central accounting system 202, which may be coupled to a wide-area network 206, such as the Internet. In another embodiment, an individual may create an account at casino 200 by operating a casino-provided user interface to central accounting system 202, or simply by providing Internet access for their guests so that the individual may create an account as just described.

In another embodiment, an individual may create an account with central accounting system 202 using any of the electronic gaming devices 102-106, electronic wagering device 110, or at one of the live games using a computing device located at or near any of the live game tables.

In any case, the individual may decide to play slot machine 106. If the individual has previously created an account with central accounting system 202, he or she may enter identification information into slot machine 106, such as a username and password, biometric information such as a fingerprint or retina scan, identification card such as a credit card, driver's license, or other means, identifying himself or herself to central accounting system 202. The identification information is ultimately provided to central accounting system 202. Central accounting system 202 matches the identification information provided by the individual to information stored in association with various accounts stored in central accounting system 202. If a match if found, central accounting system 202 provides an indication of the credit available to the individual via SAS accounting system and slot machine 106, if a balance in the account is present. In another embodiment, the individual enters an amount that the individual would like to use from his or her previously-created account and sends it along with the identification information. If validation is successful, central accounting system 202 credits a temporary account managed by SAS accounting system and debits the individual's account managed by central accounting system 202 in an amount equal to the requested amount, assuming that the individual's account in central accounting system 202 contains enough value to honor the request.

If there is no credit available in the individual's account in central accounting system 202, the individual may fund the account by providing monetary value to the slot machine in the form of cash, voucher, credit card or debit card. Slot machine 106 transmits a message to SAS accounting system 120 where the monetary value is recorded. In the case of a credit or debit card request, SAS accounting system 120 may negotiate with the individual's financial institution to obtain credit on behalf of the individual in the amount of the monetary value. In any case, the amount of the monetary value is also provided to central account system 202 where it is recorded in association with the individual's account. An indication may be sent to slot machine 106 informing the individual of the credit available for game play.

In another embodiment, the individual may not wish to establish an account with central account system 202 but, rather, simply play with cash, credit or debit. In this case, the individual provides slot machine 106 with cash, credit card information, or debit card information. As a result, slot machine 106 provides the individual a number of credits in proportion to the amount of cash, credit, or debit entered into slot machine 106 for use in playing games via slot machine 106.

The individual may use the credits to play one or more slot games traditionally offered by slot machine 106, such as slots, video poker, etc. However, the individual may also place a wager on another game being offered over a different gaming platform via slot machine 106. For example, slot machine 106 may display information relating to any number of other games available to the individual for play through slot machine 106, such as a list or graphical illustration of available seats at a number of live blackjack games being played on physical blackjack tables, a list or graphical illustration of available seats at a number of live poker games being played on physical poker tables, a list or graphical illustration of a number of roulette wheels available to accept a wager from slot machine 106, and/or a number of live craps games being played on physical craps tables. Slot machine 106 may offer two or more games simultaneously to the individual using one of a number of different display formats, such as a split-screen, or a tiled screen. In another embodiment, slot machine 106 simply offers other games via an icon on its display screen, indicating that games of live blackjack and live roulette, for example, are available for play via slot machine 106. In a related embodiment, once the individual selects one of the “other” game choices via the just-described icon, the individual is provided with a list or graphical information of available seats at one of the live games that the individual has chosen to participate.

As an example, the individual may select a game of live blackjack to play, alternatively or in addition to playing a slot game offered by slot machine 106. In one embodiment, the individual may select a particular live blackjack table and/or a particular seat any of the available live blackjack tables.

Referring to one of the live blackjack tables 112, it comprises an ability to receive real-time wagers from the individual via slot machine 106 as well as convey game information to the individual at slot machine 106 as blackjack is played on blackjack table 112. For example, a camera may be assigned to each player position and to the dealer position to capture a visual image of card values as they are dealt from a deck or multiple decks of cards by a live dealer. The video information from all of the cameras may be provided to central accounting system 202 for distribution to other gaming platforms. The live dealer at blackjack table 112 may use an electronic device to communicate with central accounting system 202 located at or near blackjack table 112 to inform central accounting system 202 when a seat has become available or when a seat has been taken by a live blackjack player at blackjack table 112. The electronic device is discussed later herein. In another embodiment, an electronic sensor may automatically determine the status of each seat and provide that information to central accounting system 202. The electronic sensor may comprise an RF sensor, a pressure sensor built into the seats, an infra-red detector, an audio or IR range finder, and/or visual detection technology to determine whether a seat is occupied or not.

Returning to the example at hand, after the individual at slot machine 106 selects a live game of blackjack and/or a seat position at one of the available blackjack tables 112, the live dealer at the selected table is notified that the individual intends to occupy a seat at the blackjack table 112 via a computing device networked to slot machine 106 and operated by the dealer (not shown). The dealer may send an acknowledgement to central accounting system 202 via the computing device indicating that he or she has received the seat request from the individual. The acknowledgment is forwarded by central accounting system 202 to slot machine 106, where it is displayed to the individual.

After the individual has successfully taken a “seat” at blackjack table 112, some or all of the video information captured by the video cameras at blackjack table 112 may be provided to slot machine 106 by central accounting system 202 for display to the individual. For example, at least the video of the dealer's position and the individual's position is sent to slot machine 106, i.e., at least the dealer's card hand and the individual's card hand are sent to slot machine 106. In most embodiments, however, video information concerning the other player's cards is also sent to slot machine 106.

The individual may place a wager on the next hand dealt by the live dealer at blackjack table 112 using slot machine 106. For example, the individual may select an amount to be wagered from the credit available in the temporary account managed by SAS accounting system 120 or in the individual's account managed by central accounting system 202. When the player enters the wager amount, an indication of the wager amount is sent to central server 202. It may also be sent directly to the electronic device associated with blackjack table 112. In another embodiment, the wager is sent from central accounting system 202 to the electronic device associated with blackjack table 112. The wager amount may also be credited to an account associated with an electronic gaming platform monitored by SAS accounting system 120. In another embodiment, the wager is credited to an account maintained by live game accounting server 124, representing casino wins/losses for gaming activity occurring at live table games. In any case, central accounting system 202 may record an indication of a wager placed via the first gaming platform for use in a game conducted on a second gaming platform.

The dealer then deals a blackjack hand to any position at blackjack table 112 that has been provided with a wager. Thus, persons seated at blackjack table 106 will receive a physical blackjack hand, as well as the position where the individual is playing remotely vie slot machine 106. As play progresses, the individual playing at slot machine 106 will be given an opportunity to “hit”, “stand”, “double-down”, etc., in accordance with the rules of blackjack. The individual and the dealer communicate with each other using slot machine 106 and the dealer's computing device, respectively. If additional wagers are placed as a result of game play, such as “doubling down”, splitting, etc., the additional wager information is provided both to central accounting system 202 and to the electronic device associated with blackjack table 112. The additional wager is, again, accounted for by central accounting serve 202 as a wager placed via first gaming platform for use in a game conducted on the second gaming platform.

At some point later, the dealer wins the hand against the individual, the individual wins the hand against the dealer, or there is a tie between the dealer and the individual. In the case where the dealer beats the individual, an indication is provided from the electronic device associated with blackjack table 112 to central accounting system 202, and central accounting system 202 determines that the wager(s) received should be credited to the second gaming platform; more specifically, live game accounting server 124 and/or to blackjack table 112. In one embodiment, the wager amount(s) is credited to live game accounting server 124/blackjack table 112 and the wager amount maintained the central accounting system 202 is zeroed out. In another embodiment, in addition to the above, the wager amount(s) is debited from an account maintained by SAS accounting system 120. Thus, when the dealer at blackjack table 112 wins a hand against the individual playing via slot machine 106, the central accounting server 202 provides a credit to the live gaming platform to properly account for the casino's win. In any case, the credits and debits may be applied at the time of the wager, at the conclusion of the hand, at the conclusion of game play by the individual, or at some other pre-determined time.

If the individual wins the hand of blackjack against the dealer, an indication of the win amount is sent from the electronic device associated with blackjack table 112 to central accounting system 202. In response, central accounting system 202 adjusts the account balance between the electronic gaming platform and the live game platform to reflect this event. In one embodiment, central accounting system 202 provides a credit to the electronic gaming platform via an adjustment entry to an account managed by SAS accounting system 120, debits an account managed by live game accounting system 124, and zeros out the account balance managed by central accounting system 202. Thus, when the individual wins a hand against the dealer at blackjack table 112 via slot machine 106, the live gaming platform provides a credit to the electronic gaming platform to properly account for the individual's win. In any case, the credits and debits may be applied at the time of the wager, at the conclusion of the hand, at the conclusion of game play by the individual, or at some other pre-determined time.

Of course, the individual may continue to play hands of blackjack against the dealer. In one embodiment, each time the individual loses or wins, central accounting system 202 tracks the wagering transactions to ensure that each gaming platform is credited or debited in an amount consistent with the actual wins and losses arising from game play related to a particular gaming platform.

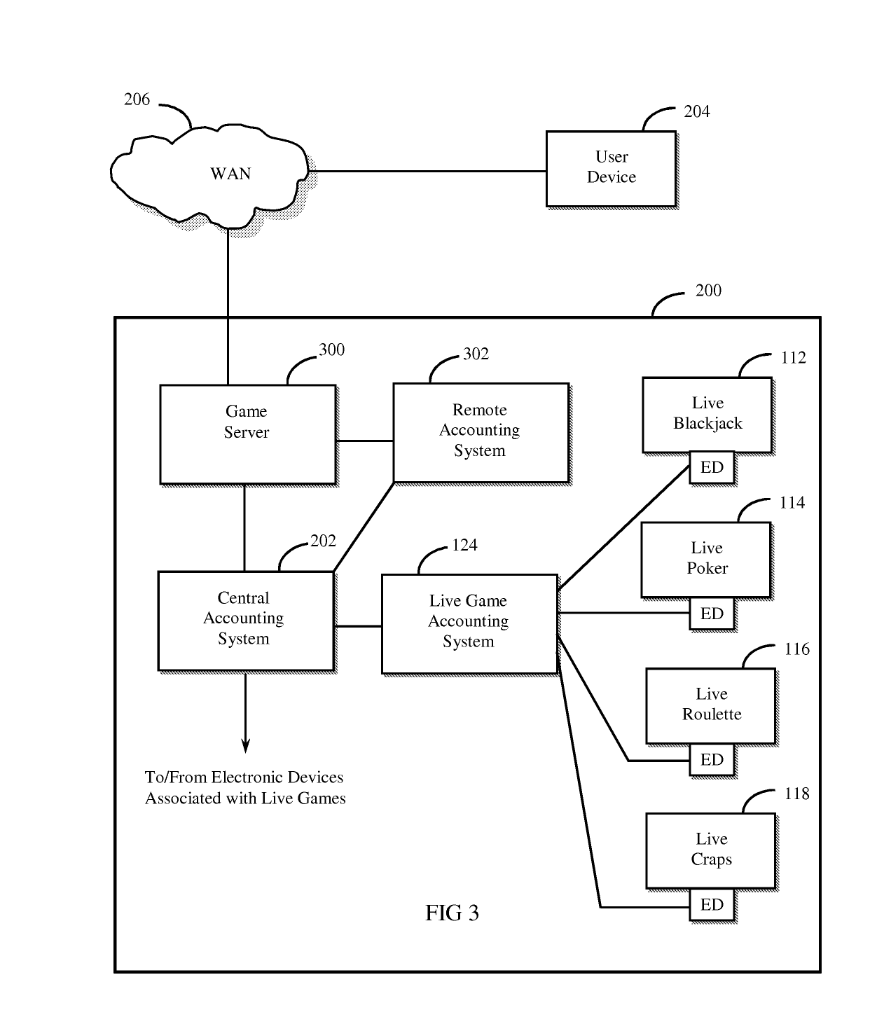

FIG. 3 is a block diagram illustrating another embodiment of an accounting system used to reconcile accounts between and among various gaming platform accounting systems as players are allowed to engage in cross-platform wagering. The live event wagering platform and the electronic gaming platform is not shown in this embodiment for convenience.

In this embodiment, an individual may play games of chance “on-line” using an electronic device 204, such as a personal computer, tablet, or smartphone, connected to a wide-area network, such as Internet 206. Remote game server 300 is also connected to Internet 206 and is in communication with electronic device 204, offering electronic games such as electronic poker, blackjack, craps, roulette, etc. The outcome of games offered by remote game server 300 is determined by an electronic Random Number Generator (RNG) typically generated by remote game server 300. The remote game server 300, Internet 206, and electronic device 204 may be considered another type of gaming platform.

Normally, an individual operating electronic device 204 is able to play games offered by remote game server 300, while remote accounting system 302 tracks financial activities associated with games offered by game server 300, similar to how any of the accounting systems 120, 122, or 124 operate, as described earlier. However, the individual may also be able to play games offered under a different gaming platform, such as the live game platform where live poker, blackjack, craps, and roulette are offered, similar to how slot machine 106 is able to offer live games to an individual operating slot machine 106. The individual operating electronic device 204 may be present with an opportunity to play, for example, one or more live games. The individual may select one of the live games to play, and then place a wager using electronic device 204.

The wager is received by remote game server 300 and by central accounting system 202, where it is recorded as a wager placed by an individual using the remote gaming platform for placement on a game being played on another gaming platform, in this case, the live game platform. The wager is then presented to a live dealer, boxman, or croupier at one of the live gaming tables. If the wager is successful, an indication of the win is provided by the dealer to an electronic device operated by the dealer to central accounting system 202 either directly, or via live game accounting system 124 and/or remote game server 300. Live game accounting system 124 may record the individual's win as a debit against the live gaming platform. Central accounting system 202 accounts for the player's win in relation to the wager(s) that was received earlier to determine if an account reconciliation is needed between the remote gaming platform and the live game platform. In the case where a wager is won via the electronic gaming platform against a game being played on the live game platform, a credit is provided to the electronic gaming platform and the live game platform is debited a related amount. The central accounting system 202 may zero out an account balance related to the remote gaming platform and the live game platform.

Of course, wagers lost by the individual are accounted for in a manner similar to the discussion above with respect to FIG. 2.

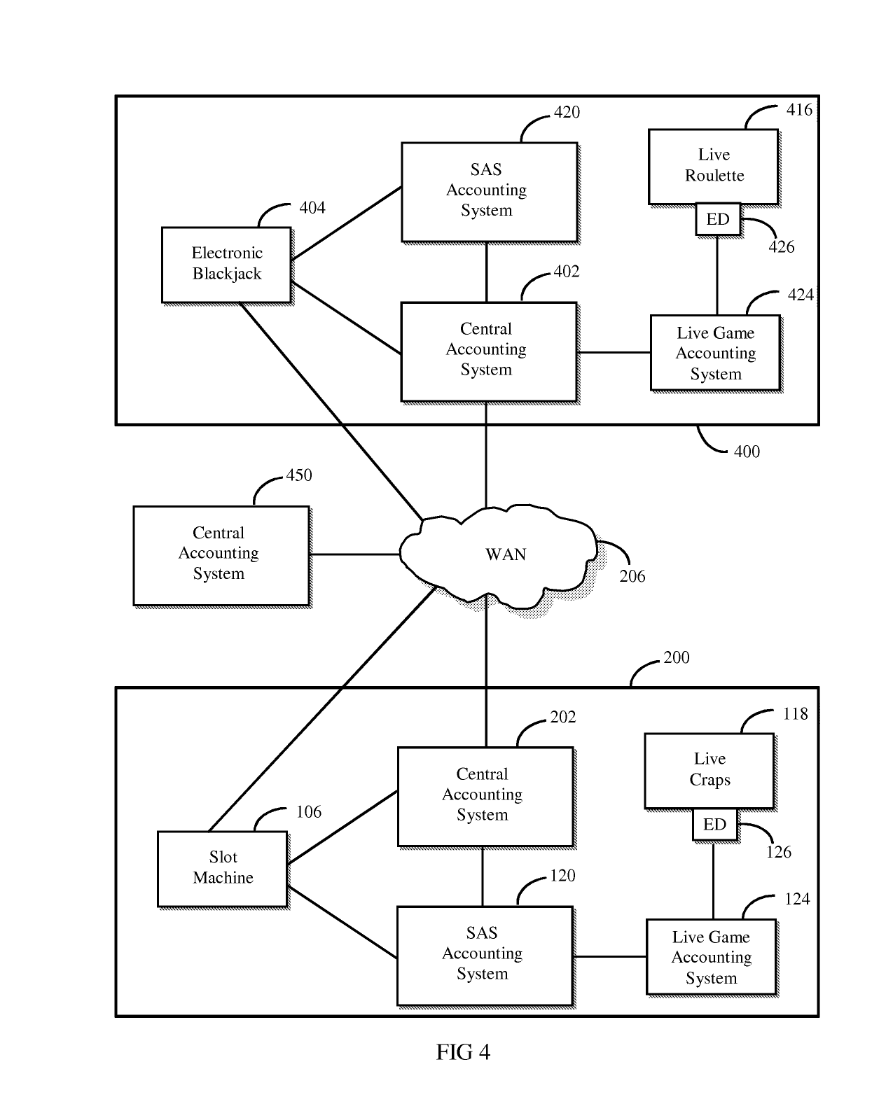

FIG. 4 is a block diagram of another embodiment, where individuals may use a first gaming platform located in a first authorized gaming establishment 400 to play a game being conducted on a second gaming platform located in a second authorized gaming establishment 200, in this embodiment, a casino. Second authorized gaming establishment 200 comprises a sub-set of already-discussed components, such as slot machine 106, SAS accounting system 120, central accounting system 202, live game accounting server 124 and an electronic device 126 associated with a craps table 118. First authorized gaming establishment 400 comprises the same or similar components, shown as video poker machine 404, SAS accounting system 420, central accounting system 402, live game accounting server 424 and an electronic device 426 associated with a craps table 418. In this embodiment, an individual operating an electronic gaming device as part of a first gaming platform, such as video poker machine 404 located at casino 400, may play a live game, such as a live game of craps being played on craps table 118 in casino 200. In addition, an individual operating an electronic gaming device as part of a first gaming platform, such as slot machine 106 located at casino 200, may play a live game, such as a live game of roulette being played on roulette table 416 in casino 400. Reconciliation between casinos may be achieved by intra-casino accounting server 450.

For example, an individual may begin operating video poker machine 404 by inserting cash, or a credit or debit card into video poker machine 404, or access an account maintained by central accounting system 402 having a pre-established credit balance. SAS accounting system 420 records the amount that the individual provided. The individual may be presented with a selection of live games to play on video poker machine 404, some of which may be live games being played in other casinos or other authorized gaming establishments, such as casino 200.

Upon selection of a live game to play, such as a game of craps in casino 200, a signal is sent by video poker machine 404 to electronic device 126 through one of multiple possible routes. For example, video poker machine 404 may send the signal directly to Internet 206 and then directly to electronic device 126 using common TCP/IP protocols. In one embodiment, the electronic device 126 and video poker machine 404 each comprises an IP address that uniquely identifies electronic device 126 and video poker machine 404 to the network and to each other. A number of possible alternative routes of transmission are possible.

Upon receipt of the signal from video poker machine 404 at electronic device 126, a boxman at craps table 118 transmits an acknowledgement back to video poker machine 404, indicating that the individual at video poker machine 404 may now place wagers in association with the live game of roulette being played on roulette table 118.

At some point, intra-casino accounting server 450 receives notification that the individual at video poker machine 404 is authorized to place wagers on a roulette game located in casino 200, either by a signal from video poker machine 404 and/or electronic device 126. An account may be created by intra-casino accounting server 450 to account for gaming activities, such as wagers and winnings, with respect to the individual at video poker machine 404. In another embodiment, intra-casino accounting server 450 maintains an account for each casino that participates in intra-casino gaming. In yet another embodiment, an account is created for each casino pair participating in intra-casino gaming.

For example, if casinos A, B, and C each participate in intra-casino gaming with each other, intra-casino accounting server 450 creates three accounts: a first account related to wagers and game outcomes between casino A and B, a second account related to wagers and game outcomes between casino A and C, and a third account related to wagers and game outcomes between casino B and C. In this way, a reconciliation among casino's A, B, and C may be performed. The term “game outcomes” refers to win/loss results, as well as amounts associated with wins or losses.

Next, the individual may place a wager on a particular event occurring on craps table 118, via video poker machine 404. When the wager is placed, a signal is sent to electronic device 126 so that it may be provided to the boxman and also to intra-casino accounting server 450. Intra-casino accounting server 450 adjusts an account balance associated with gaming activities occurring between first authorized gaming establishment 400 and second authorized gaming establishment 200. In another embodiment, the gaming platform types are also recorded. In this case, for example, intra-casino accounting server 450 would record that the wager was placed from an electronic gaming platform in the first authorized gaming establishment 400 to a live gaming platform located at the second authorized gaming establishment 200.

If the wager is successful at craps table 118, the boxman indicates a win via electronic device 126 and, in one embodiment, an amount of winnings, including the individual's wager plus an amount won from the successful wager. This information is provided to Internet 206 and then to intra-casino accounting server 450 and video poker machine 404. Intra-casino accounting server 450 adjusts the account balance to reflect the individual's win, as indicated by device 126.

If the wager at craps table 118 is not successful, the boxman indicates a loss via electronic device 126. This information is provided to Internet 206 and then to intra-casino accounting server 450 and video poker machine 404. In one embodiment, the account balance is credited to an account maintained by the second authorized gaming establishment 200 and a related amount is debited against an account managed by the first authorized gaming establishment 400. In other embodiment, intra-casino accounting server 450 does not debit/credit any accounts until the individual stops playing, or at some predetermined time, for example, at predetermined time periods such as once per day, one per week, once per month. In addition, a payment may be provided from one authorized gaming establishment to another as part of the reconciliation process, i.e., to account for winnings and losses that occur from intra-casino waging.

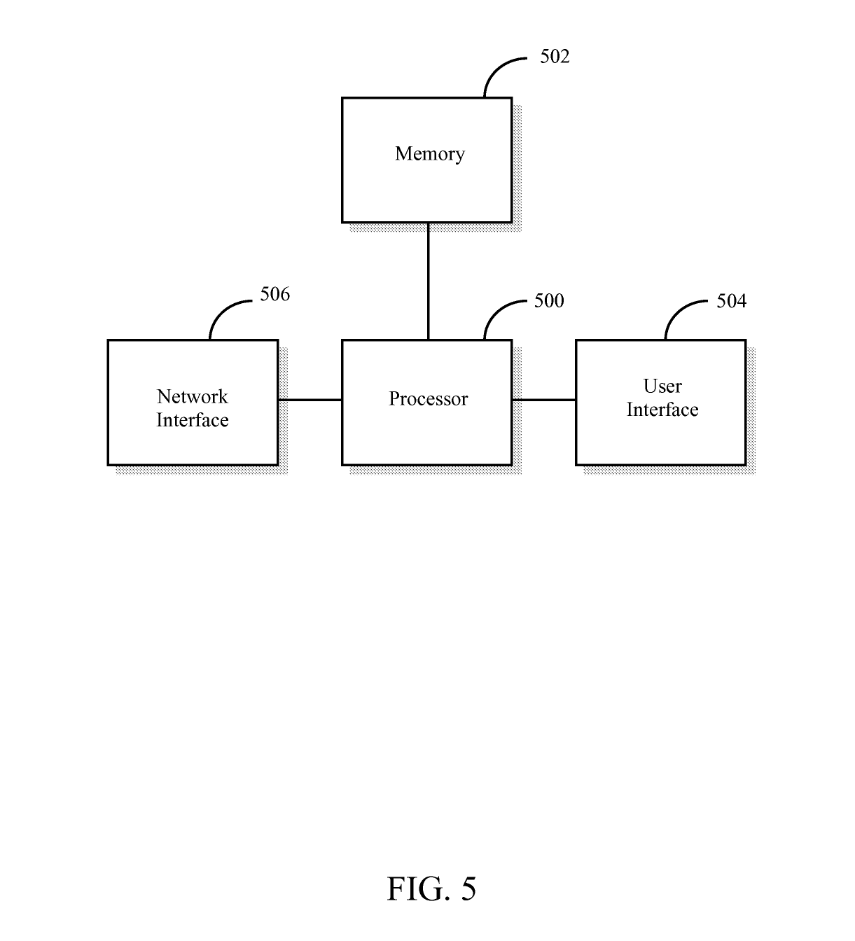

FIG. 5 is a functional block diagram of one embodiment of either central accounting system 202 or intra-casino accounting server 450. Shown are processor 500, memory 502, user interface 504, and network interface 506. It should be understood that in some embodiments, not all of the functional blocks shown in FIG. 5 are necessary for the proper operation of central accounting system 202, and that some functionality has been omitted for purposes of clarity.

Processor 500 comprises a general-purpose microprocessor well known in the art or it may comprise a custom or semi-custom ASIC able to carry out the functionality required for central accounting system 202 to process, account, and reconcile accounts, wagering, and pay-out information. Processor 500 generally executes processor-readable, or processor-executable, instructions stored in one or more mediums, such as memory 502, that control most or all of the functionality of central accounting system 202. Examples of memory 502 comprise one or more electronic memories such as RAM, ROM, hard drives, flash memory, EEPROMs, UVPROMs, etc. Network interface 506 comprises hardware and/or software configured to send and receive electronic communications between central accounting system 202 and other networked devices, such as any of the electronic devices—associated with the live gaming tables, other accounting systems/servers, gaming terminals, and/or remote electronic devices such as computers, tablets, and smartphones. Network interface may comprise circuitry necessary to process the electronic communications and may be designed specifically to communicate in a predetermined communication protocol, such as TCP/IP, RS-232, or other well-known form of digital communication protocols.

User interface 506 generally comprises hardware and/or software necessary for allowing a user of central accounting system 202, such as an authorized technician or operator, to perform various duties related to the maintenance and upkeep of central accounting system 202. Such duties may include installing or updating software, performing trouble-shooting activities, accessing accounts, and so on. User interface 506 may comprise a keyboard, keypad, push-buttons, switches, a video display, a touch-screen device, a card reader, a microphone, an image capture device such as a still camera or video camera, a coin and/or bill acceptor, a speaker, a ticket printer, an RS-232 port, a USB port, a card reader, a network port, and/or virtually any other device that allows a user of central accounting system 202 to communicate with central accounting system 202.

Memory 502 is also used to store account balance information, such as a balance associated with two gaming platforms located in a single authorized gaming establishment, a balance associated with two authorized gaming establishments, a balance associated with a single gaming platform or authorized gaming establishment, individual account information, or any other information pertinent to gaming activities between/among two or more gaming platforms.

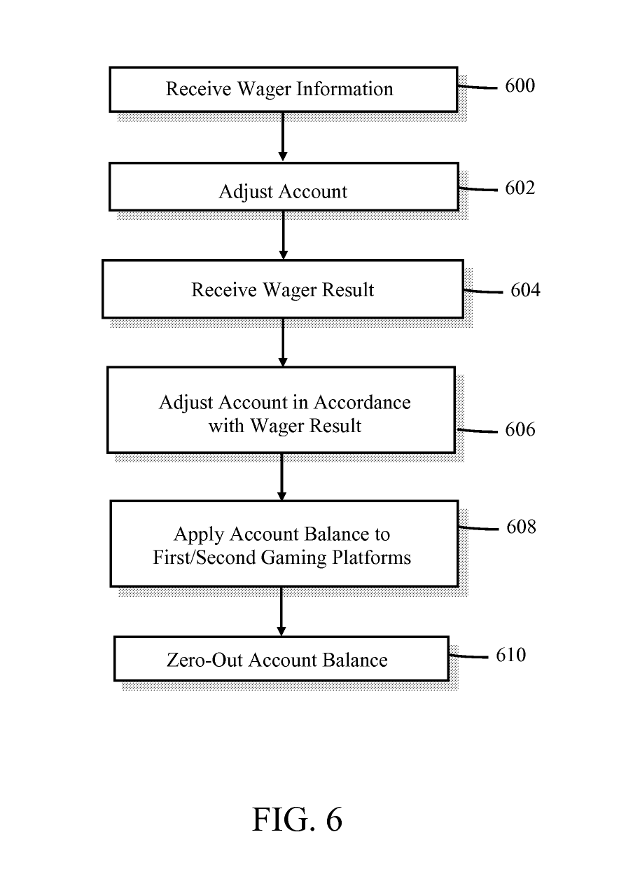

FIG. 6 is a flow diagram illustrating one embodiment of a method for accounting for cross-platform wagering. The method is implemented by a processor, such as processor 500 shown in FIG. 5, located in central accounting system 202 or intra-casino accounting server 450, executing processor-readable instructions stored in a memory, such as memory 502. For purposes of discussion of the process steps below, whenever reference is made to processor 500 or to central accounting system 202, it shall be assumed that intra-casino accounting server 450 could be used in the alternative. Further, it should be understood that in some embodiments, not all of the steps shown in FIG. 6 are performed and that the order in which the steps are carried out may be different in other embodiments. It should be further understood that some minor method steps have been omitted for purposes of clarity.

The method begins at block 600, where central accounting system 202 receives an indication of a wager placed by an individual using a first gaming platform over a network interface, the wager for use in a game being played on a second gaming platform. For example, the wager may comprise a wager amount of $10 placed by an individual operating an electronic slot machine 106 for participation in a live hand of blackjack being played on blackjack table 112.

At block 602, processor 800 adjusts an account stored in memory 802 in an amount corresponding to the wager. The account may be debited, or reduced, or credited, or increased. It is immaterial whether this account is credited or debited, or increased or decreased, as long as other accounts, such as ones monitoring the various gaming platforms, are in conformance with the account stored in memory 802, i.e., as in the case of double-entry account keeping.

In the case where central accounting system 202 provides central accounting services between/among gaming platforms located in a single authorized gaming establishment, the account represents a financial relationship between the two gaming platforms involved in the wager. In this example, the first gaming platform comprises electronic gaming machines monitored by SAS accounting system 120 and the second gaming platform comprises table games monitored by live game accounting server 124. In an embodiment where one gaming platform is located within a first authorized gaming establishment and the second gaming platform is not located within first authorized gaming establishment (i.e., the second gaming platform is located at a second authorized gaming establishment or at an individual's home, in the case of Internet-based gaming), the account represents a financial relationship between the first authorized gaming establishment and the entity associated with the second gaming platform.

At some point later, at block 604, processor 800 receives an indication from the second gaming platform whether the wager was successful or unsuccessful over the network interface. For example, the indication may comprise an amount that the individual won as a result of winning a blackjack hand against a live dealer, otherwise known as “the house”.

At block 606, processor 800 alters the account in accordance with the indication of whether the wager was successful or unsuccessful. In one embodiment, if the wager was successful, the account is reduced in an amount according to the received indication. If the wager was unsuccessful, in one embodiment, no change is made to the account.

At block 608, an account balance associated with the account is applied to an account associated with the first gaming platform and the second gaming system. For example, if the account balance is positive, i.e., the individual won money, this indicates that the individual playing a game on the second gaming platform via the first gaming platform has lost money due to wagering activities. In this case, a first accounting system monitoring financial transactions of games offered in accordance with the first gaming platform (e.g., SAS 120) would show that the first gaming platform profited from the individual's gaming activities in an amount equal to the individual's loss. A second accounting system monitoring financial transactions of games offered in accordance with the second gaming platform (e.g., live game accounting server 124), in one embodiment, would show neither a profit nor a loss due to wagering activities by the individual playing games via slot machine 106. However, the accounting system associated with the first gaming system has not really profited from the individual's wagering, because the wagers were applied to games occurring via the second gaming system. Thus, at block 608, in one embodiment, central accounting system 202 sends a command to SAS accounting system 120 to reduce an account maintained by SAS accounting system 120 and a command is sent to the second accounting system, i.e., live game accounting system 124 to credit, or increase an account managed by live game accounting system to account for the casino's win on the live gaming table.

If the account balance in the account maintained by central accounting system 202 is negative, in one embodiment this indicates that the individual is net-positive in his or her wagering, i.e., the individual has won money from the authorized gaming establishment associated with, in this example, the second gaming platform. In this case, in one embodiment, the first accounting system associated with the first gaming platform (e.g., SAS 120) would show that the first gaming platform lost money by virtue of the individual's gaming activities in an amount equal to the individual's winnings. The second accounting system associated the second gaming platform (e.g., live game accounting server 124), in one embodiment, would show neither a profit nor a loss due to wagering activities by the individual playing games via slot machine 106. However, the first gaming platform has not actually lost any money due to the individual's winnings, because these winnings were a result of gambling occurring via the second gaming system. Thus, at block 608, in one embodiment, central accounting system 202 sends a command to SAS accounting system 120 to increase or credit the account maintained by SAS accounting system 120, and a command is sent to the second accounting system, i.e., live game accounting system 124 to debit, or reduce the account managed by live game accounting system 124 to account for the casino's loss on the live gaming table.

At block 610, after the account balance of the account maintained by central accounting system 202 has been applied to other accounts, as described above, the balance of this account is adjusted to zero, to reflect that a reconciliation has occurred between accounts.

It should be understood that throughout this disclosure the terms “debit”, “credit”, and account balances being “positive” or “negative” have been discussed as having a certain meaning. For example, a debit to an account may mean that an individual has won money or it may mean that an individual has lost money due to gaming activities while a complimentary account, for example an account associated with an authorized gaming establishment, will indicate that the individual has won money or lost money, respectively. In other words, these terms should be considered relative to one another.

The methods or algorithms described in connection with the embodiments disclosed herein may be embodied directly in hardware or embodied in processor-readable instructions executed by a processor. The processor-readable instructions may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in an electronic gaming device. In the alternative, the processor and the storage medium may reside as discrete components.

Accordingly, an embodiment of the invention may comprise a non-transitory processor-readable media embodying code or processor-readable instructions to implement the teachings, methods, processes, algorithms, steps and/or functions disclosed herein.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

I claim:

1. A system for providing accounting between and among different gaming platforms, comprising:
a first gaming platform for allowing an individual to participate in a game being played on a second gaming platform, and for receiving a wager from the individual via the first gaming platform for use in the game; and
a server coupled to the first gaming platform and the second gaming platform for determining an amount owed to the first gaming platform by the second gaming platform depending on an outcome of the wager.

2. The system of claim 1, further comprising:
a first accounting system coupled to the first gaming platform and the server for tracking payouts by the first gaming platform; and
a second accounting system coupled to the second gaming platform and the server for tracking payouts by the second gaming platform; wherein
the server provides a credit to the first accounting system if the wager was successful.

3. The system of claim 1, wherein the first gaming platform and the second gaming platform are both located on the premises of an authorized gaming provider.

4. The system of claim 1, wherein the first gaming platform is located on the premises of a first authorized gaming provider and the second gaming platform is not located on the premises of the first authorized gaming provider.

5. The system of claim 4, wherein the server is further configured to:
generate a report indicative of the credit owed to the first authorized gaming establishment by the second authorized gaming establishment.

6. The system of claim 5, wherein the server is further configured to provide reconciliation and settlement between the second entity and the first entity.

7. The system of claim 1, wherein the first gaming platform comprises an electronic device and the second gaming platform comprises a live table game.

8. The system of claim 1, wherein the first gaming platform comprises a first electronic gaming device located on the premises of a first authorized gaming provider and the second gaming platform comprises live table game located on the premises of a second authorized gaming provider.

9. An apparatus for providing accounting between and among different gaming platforms, comprising:
a communication interface for sending and receiving wagering and game outcome information between a first gaming platform and a second gaming platform;
a memory for storing account information related to the wagering and game outcome information between the first gaming platform and the second gaming platform; and
a processor configured to:
determine an amount owed to the first gaming platform by the second gaming platform, or by the second gaming platform to the first gaming platform, based on wagering and game outcome results.

10. The apparatus of claim 9, wherein determining an amount owed comprises:
receiving an indication of a first wager from the first gaming platform for use in a game conducted on the second gaming platform;
crediting the account information in accordance with the first wager;
receiving a result of the wager from the second gaming platform; and
debiting the account in accordance with the result.

11. The apparatus of claim 9, wherein determining an amount owed comprises:
receiving an indication of a first wager from the first gaming platform for use in a game conducted on the second gaming platform;
debiting the account information in accordance with the first wager;
receiving a result of the wager from the second gaming platform; and
crediting the account in accordance with the result.

12. The apparatus of claim 9, wherein:
the first gaming platform is coupled to a first accounting system for tracking payouts by the first gaming platform;
the second gaming system is coupled to a second accounting system for tracking payouts by the second gaming platform; and
the processor provides a credit to the second accounting system from the first accounting system if the processor determines that a credit is owed to the second gaming platform from the first gaming platform.

13. The apparatus of claim 9, wherein the first gaming platform and the second gaming platform are both located on the premises of an authorized gaming provider.

14. The apparatus of claim 9, wherein the first gaming platform is located on the premises of a first authorized gaming provider and the second gaming platform is not located on the premises of the first authorized gaming provider.

15. The apparatus of claim 9, wherein the first gaming platform comprises an electronic device and the second gaming platform comprises a live table game.

16. The apparatus of claim 9, wherein the first gaming platform comprises a first electronic gaming device located on the premises of a first authorized gaming provider and the second gaming platform comprises live table game located on the premises of a second authorized gaming provider.

17. The apparatus of claim 14, wherein the processor is further configured to:
generate a report indicative of the credit by one of the authorized gaming establishments to the other authorized gaming establishment.

18. A method for accounting for cross-platform wagering, comprising:
receiving an indication of a wager placed by an individual using a first gaming platform over a network interface, the wager for use in a game being conducted on a second gaming platform;
adjusting an account balance stored in a memory, the account balance associated with an amount owed between the first gaming platform and the second gaming platform;
receiving an indication from an electronic device associated with the second gaming platform whether the wager was successful or unsuccessful over the network interface;
adjusting the account balance in accordance with whether the wager was successful or unsuccessful; and
determining an amount owed from the first gaming platform to the second gaming platform, or vice-versa, depending on the account balance.

19. The method of claim 18, wherein:
the first gaming platform comprises an electronic gaming machine and the second gaming platform comprises a live table game.

20. The method of claim 18, further comprising:
providing a credit to a first accounting system associated with the first gaming platform if the second gaming platform owes the first gaming platform; and
providing a second credit to a second accounting system associated with the second gaming platform if the first gaming platform owes the second gaming platform.
